(19) United States
(12) Patent Application Publication
(10) Pub. No.: US 2026/0276873 A1
(43) Pub. Date: Sep. 17, 2026

(54) FIELD ETCH TO ENHANCE IMAGE SHARPNESS OF AUGMENTED REALITY WAVEGUIDE COMBINERS

(71) Applicant: Applied Materials, Inc., Santa Clara, CA (US)

(72) Inventors: Kunal SHASTRI, Santa Clara, CA (US); David Alexander SELL, Santa Clara, CA (US); Samarth BHARGAVA, Saratoga, CA (US)

(21) Appl. No.: 19/470,560

(22) PCT Filed: Jun. 27, 2024
(86) PCT No.: PCT/US2024/035901

§ 371 Date: Sep. 29, 2025

Related U.S. Application Data
(60) Provisional application No. 63/524,424, filed on Jun. 30, 2023.

(51) Int. Cl. G02B 5/18; G02B 1/11; G02B 27/00; G02B 27/01

(52) U.S. Cl. CPC G02B 5/1857; G02B 5/1819; G02B 27/0081; G02B 27/0172; G02B 1/11; G02B 2027/0178

(57) ABSTRACT

The present disclosure provides waveguides and methods of forming thereof. The waveguides include a plurality of gratings. The plurality of gratings include grating structures disposed over a waveguide substrate. The grating structures include a grating depth. A waveguide layer is disposed over the waveguide substrate between each of the plurality of gratings and an edge of the waveguide substrate. The waveguide layer has an etch depth. The etch depth is less than the grating depth.

### BACKGROUND

### Field

Embodiments of the present disclosure generally relate to waveguide combiners. More specifically, embodiments described herein provide for waveguide combiners with field etching in a waveguide layer.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses that display a virtual reality environment that replaces an actual environment.

Augmented reality enables an experience in which a user can see through the display lenses of the glasses or other HMD device to view the surrounding environment while also seeing images of virtual objects that are generated for display and appear as part of the environment. Diffractive waveguide combiners are used in some augmented reality applications to transmit virtual images, graphics, and video that enhance or augment the environment that the user experiences. Wavefront aberrations in the pupil of the images, graphics, and video can cause a loss of image sharpness. It is therefore desirable to develop waveguide combiners that reduce wavefront aberrations.

### SUMMARY

The present disclosure generally relates to waveguide combiners, including waveguide combiners with field etching in a waveguide layer.

In an aspect, the present disclosure provides waveguides. The waveguides include a plurality of gratings. The plurality of gratings include grating structures disposed over a waveguide substrate. The grating structures include a grating depth. A waveguide layer is disposed over the waveguide substrate between each of the plurality of gratings and an edge of the waveguide substrate. The waveguide layer has an etch depth. The etch depth is less than the grating depth.

In another aspect, the present disclosure provides waveguides. The waveguides include a plurality of gratings. The plurality of gratings include grating structures disposed over a waveguide substrate. The grating structures include a grating depth. A waveguide layer is disposed over the waveguide substrate between each of the plurality of gratings and an edge of the waveguide substrate. The waveguide layer has a first sub-layer disposed over the waveguide substrate. A second sub-layer is disposed over the first sub-layer. The waveguide layer includes an etch depth from a top surface of the second sub-layer to the top surface of the grating structures.

In another aspect, the present disclosure provides methods for forming waveguides. The methods include determining an etch depth for etching a waveguide layer of a waveguide. The waveguide layer including a first sub-layer and a second sub-layer. The etch depth is less than a grating depth of a plurality of gratings of the waveguide. The second sub-layer is etched to the etch depth.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the disclosure and are therefore not to be considered limiting of its scope, as the disclosure may admit to other equally effective embodiments.

FIG. 1 is a schematic top view of a waveguide combiner according to embodiments described herein.

FIG. 2 is a schematic side view of a portion of a waveguide according to embodiments described herein.

FIG. 3 is a schematic side view of a portion of a waveguide according to embodiments described herein.

FIG. 4 is a flowchart of a method for forming a waveguide.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to waveguide combiners. More specifically, embodiments described herein provide for waveguide combiners with field etching in a waveguide layer.

Diffractive waveguide combiners (also referred to herein as waveguide combiners and waveguides) used in augmented reality applications tend to use gratings to redirect light from a light-engine to a user's eye. This light direction may be achieved using an in-coupler grating to couple an incident pupil into total internal reflection (TIR) followed by pupil expander and out-coupler gratings to replicate and out-couple the pupil, respectively. The sharpness of the image seen by the user depends on the ability of the waveguide to minimize wavefront aberrations in the pupil as the pupil is guided from the light-engine to the user's eye.

The loss of image sharpness in waveguide combiners, due to wavefront aberrations in the pupil, may be caused by TIR phase discontinuity at grating boundaries in waveguide combiners. When a pupil corresponding to a certain wavelength and field-of-view (FOV) is TIR-reflected at the boundary of a grating and a non-grating region, the amplitude and phase of the two portions of the pupil that interact with the two different regions are usually not the same. The discontinuous amplitude and phase across the pupil correspond to a point spread function that is no longer diffraction limited, resulting in a degradation of the image sharpness as measured by a modulation transfer function (MTF). Depending on the substrate thickness and pupil size, the pupil may encounter the same grating boundary multiple times, further degrading the MTF.

In embodiments of the present disclosure, to reduce this phase tear at the boundary between the grating and non-grating region, a waveguide layer in the non-grating region may have a depth determined to cause the phase of a pupil reflected in the grating region to more closely match the phase of the pupil reflected in the non-grating region. The depth of the waveguide layer may be determined based on depths and duty cycles of one or more (e.g., all) of the gratings in the waveguide combiner. The determined depth of the waveguide layer may be less than at least one of the depths of gratings of the waveguide. Providing a waveguide layer with the determined depth on a waveguide may cause the waveguide to have a higher MTF than waveguides lacking the waveguide layer.

Etching the waveguide layer to the determined depth, as described in this disclosure, can be independently implemented in a wide class of waveguides without changing the designs or architectures of the grating and non-grating regions of those waveguides. The architecture described in this disclosure uses only one extra global etch step as compared with previously known techniques, while the enhanced image sharpness or MTF enabled by the described architecture may greatly enhance the user experience and value of the waveguide display.

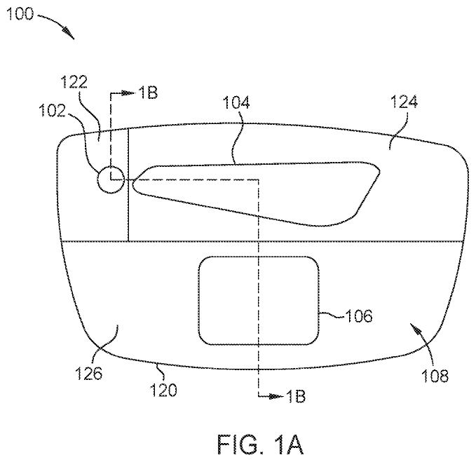

FIG. 1 is a schematic top view of a waveguide combiner 100 according to embodiments described herein. It is to be understood that the waveguide combiner 100 described below is an exemplary waveguide combiner. The waveguide combiner 100 has at least one of an in-coupler grating 102, a pupil expander grating 104, an out-coupler grating 106, and a waveguide layer 108 disposed over a waveguide substrate 128. The waveguide substrate 128 has an edge 120. The waveguide layer 108 is disposed over the waveguide substrate 128 between each of the one or more gratings (e.g., the in-coupler grating 102, the pupil expander grating 104, or the out-coupler grating 106) and the edge 120. The in-coupler grating 102 receives incident beams of light (a virtual image) having an intensity from a microdisplay. The incident beams of light undergo total-internal-reflection (TIR) and propagate in the waveguide combiner 100 in order to direct the virtual image to the pupil expander grating 104. The incident beams of light continue under TIR and propagate in the waveguide combiner 100 in order to direct the virtual image to the out-coupler grating 106 where the incident beams of light are out-coupled to the user. As the incident beams of light propagate in TIR in the waveguide combiner 100, some of the beams of light will be incident on the in-coupler grating 102, the pupil expander grating 104, and the out-coupler grating 106, while some of the beams of light will be incident on areas of the waveguide layer 108 adjacent thereto.

The waveguide layer 108 includes a first blanket area 122. The first blanket area 122 includes an area surrounding the in-coupler grating 102. The first blanket area 122 includes a first blanket depth 130, as shown in FIG. 1B. The first blanket depth 130 is based on the depths and duty cycles of the in-coupler grating 102. For example, the first blanket depth 130 can be about 40% to about 60%, e.g., about 40% to about 55%, about 45% to about 55%, or about 48% to about 52%, of the height of the in-coupler grating 102. Without being bound by theory, the first blanket area 122 being about 40% to about 60% of the in-coupler grating 102 can allow for enhanced image sharpness compared to conventional waveguide combiners.

The waveguide layer 108 includes a second blanket area 124. The second blanket area 124 includes an area surrounding the pupil expander grating 104. The second blanket area 124 includes a second blanket depth 132, as shown in FIG. 1B. The first blanket depth 130 and the second blanket depth 132 can be different and/or similar. The second blanket depth 132 is based on the depths and duty cycles of the pupil expander grating 104. For example, the second blanket depth 132 can be about 40% to about 60%, e.g., about 40% to about 55%, about 45% to about 55%, or about 48% to about 52%, of the height of the pupil expander grating 104. Without being bound by theory, the second blanket area 124 being about 40% to about 60% of the height of the pupil expander grating 104 can allow for enhanced image sharpness compared to conventional waveguide combiners.

The waveguide layer 108 includes a third blanket area 126. The third blanket area 126 includes an area surrounding the out-coupler grating 106. The third blanket area 126 includes a third blanket depth 134, as shown in FIG. 1B. The first blanket depth 130, second blanket depth 132, and third blanket depth 134 can be different and/or similar. The third blanket depth 134 is based on the depths and duty cycles of the out-coupler grating 106. For example, the third blanket depth 134 can be about 40% to about 60%, e.g., about 40% to about 55%, about 45% to about 55%, or about 48% to about 52%, of the height of the out-coupler grating 106. Without being bound by theory, the third blanket area 126 being about 40% to about 60% of the height of the out-coupler grating 106 can allow for enhanced image sharpness compared to conventional waveguide combiners.

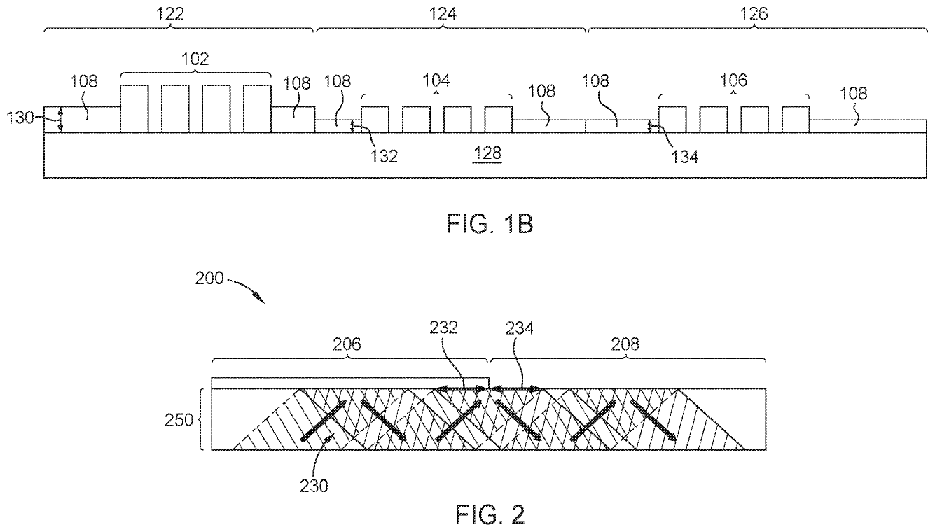

FIG. 2 is a schematic side view of a portion 200 of a waveguide combiner that does not include a waveguide layer 108. The portion 200 includes a diffraction grating 206 disposed over a waveguide substrate 250. The diffraction grating 206 may be an in-coupler grating 102, a pupil expander grating 104, or an out-coupler grating 106.

A pupil 230 in TIR is shown within the substrate 250. A portion 232 of the pupil 230 is undergoing TIR in the diffraction grating 206. Another portion 234 of the pupil 230 is undergoing TIR in a non-grating region 208. When a pupil corresponding to a certain wavelength and FOV is TIR-reflected at the boundary of the diffraction grating 206 and the non-grating region 208, as illustrated in FIG. 2, the amplitude and phase of the two portions 232 and 234 of the pupil 230 that interact with the diffraction grating 206 and the non-grating region 208 are usually not the same. The discontinuous amplitude and phase across the pupil 230 correspond to a point spread function that is no longer diffraction limited, resulting in a degradation of the image sharpness, as measured by the MTF. Depending on the substrate thickness and pupil size, a pupil may encounter the same grating boundary multiple times, further degrading the MTF.

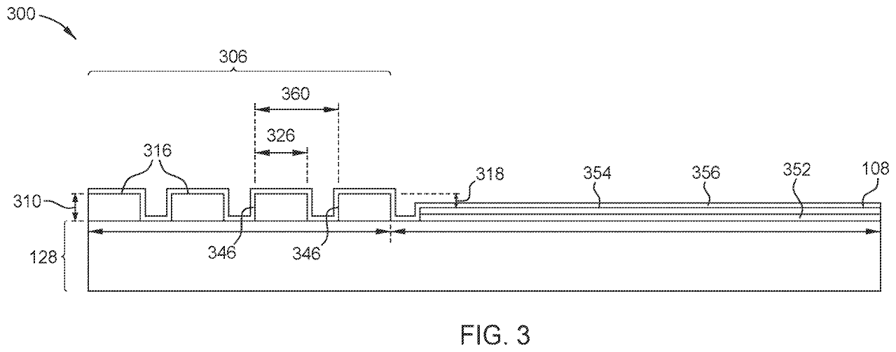

FIG. 3 is a schematic side view of a portion 300 of a waveguide combiner 100 according to embodiments described herein. The portion 300 includes a diffraction grating 306. The diffraction grating 306 includes grating structures 316 disposed over the waveguide substrate 128. The diffraction grating 306 has a pitch 360. The pitch 360 is determined from distances between first edges 346 of the grating structures 316. The diffraction grating 306 may include a portion of one of the in-coupler grating 102, the pupil expander grating 104, or the out-coupler grating 106. The grating structures 316 have a depth 310 and line width 326. The diffraction grating 306 has a duty cycle that is determined by dividing the line width 326 by the pitch 360. The waveguide substrate 128 has an edge 120 (shown in FIG. 1).

The portion 300 also includes a waveguide layer 108 disposed over the waveguide substrate 128. The waveguide layer 108 is disposed over the waveguide substrate 128 between each of the one or more gratings (e.g., the in-coupler grating 102, the pupil expander grating 104, or the out-coupler grating 106) and the edge 120. The waveguide layer 108 has a depth 318. The waveguide layer 108 includes titanium oxide (TiO), niobium oxide (NbO), or a combination thereof. Optionally, the waveguide layer 108 can include a first sub-layer 352. The first sub-layer 352 includes niobium oxide (NbO). The first sub-layer 352 can include about 50% to about 100% of the height of the waveguide layer 108. Optionally, the waveguide layer 108 can include a second sub-layer 354. The second sub-layer 354 includes titanium oxide (NbO). The second sub-layer 354 can include about 1% to about 50% of the height of the waveguide layer 108. Without being bound by theory, the second sub-layer 354 being titanium oxide can reduce manufacturing costs and allowing for precise waveguide layer heights to be formed, thereby increasing image sharpness compared to conventional waveguide combiners.

The waveguide substrate 128 may be formed from any suitable material, provided that the waveguide substrate 128 can adequately transmit light in a desired wavelength or wavelength range and can serve as an adequate support for the gratings (e.g., the in-coupler grating 102, the pupil expander grating 104, or the out-coupler grating 106) and waveguide layer 108 described herein. The material of the waveguide substrate 128 has a refractive index that is lower than the refractive index of materials of the grating structures 316 described herein. Substrate selection may include substrates of any suitable material, including, but not limited to, amorphous dielectrics, non-amorphous dielectrics, crystalline dielectrics, silicon-containing materials, polymers, and combinations thereof. In one embodiment, which can be combined with other embodiments described herein, the waveguide substrate 128 consists of one or more of silicon (Si), silicon dioxide (SiO₂), silicon carbide (SiC), fused silica, diamond, or quartz materials. In another embodiment, which can be combined with other embodiments described herein, the waveguide substrate 128 consists of one or more of nitrogen, titanium, niobium, lanthanum, zirconium, or yttrium containing-materials. The waveguide substrate 128 may include optical material having a refractive index of about 2, e.g., about 1.7 to 2.3, about 1.8 to 2.2, about 1.9 to 2.1, or about 2.0 to 2.1.

The grating structures 316 may be nanostructures having sub-micron dimensions, e.g., nano-sized dimensions. The nanostructures can include a blazed grating structure, a staircase grating structure, a vertical grating structure, or a combination thereof. The grating structures may include, but are not limited to, one or more of SiC, silicon oxycarbide (SiOC), titanium dioxide (TiO₂), SiO₂, vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), silicon mononitride (SiN), silicon oxynitride (SiON), barium titanate (BaTiO₃), diamond like carbon (DLC), hafnium(IV) oxide (HfO₂), lithium niobate (LiNbO₃), or silicon carbon-nitride (SiCN) containing materials.

The grating structures 316 may include optical material having a refractive index greater than or equal to 2.0, i.e., a high refractive index. In examples, the optical material has a refractive index in a range from about 2.0 to 2.7. In one example, the optical material has a refractive index of 2.4. The optical material having the high refractive index may include nitrides or carbides of the material of the waveguide substrate 128.

In embodiments of the present disclosure, to reduce a phase tear at the boundary between the diffraction grating 306 and the waveguide layer 108, the waveguide layer 108 may be etched to the depth 318 to better match the phase of the pupil reflected by the diffraction grating 306 and the phase of the pupil reflected by the waveguide layer 108. For example, the second sub-layer 354 may be etched to the depth 318 to better match the phase of the pupil reflected by the diffraction grating 306 and the phase of the pupil reflected by the waveguide layer 108. The depth 318 (e.g., the etch depth) of the waveguide layer 108 may be determined based on the depths and duty cycles of one or more (e.g., all) of the gratings (e.g., the in-coupler grating 102, the pupil expander grating 104, or the out-coupler grating 106) in the waveguide combiner 100. The depth 318 of the waveguide layer 108 may be determined based on an MTF of the waveguide 100 such that the waveguide 100 with has a higher MTF than other waveguides.

Optionally, an anti-reflective layer 356 can be disposed over the waveguide combiner 100. The anti-reflective layer 356 can include a material having a refractive index of less than 1.99, e.g., about 1.0 to about 1.99, about 1.0 to about 1.5, or about 1.0 to about 1.2. The anti-reflective layer can include silica oxide. The anti-reflective layer can include a depth of about 50 nm to about 150 nm, e.g., about 50 nm to about 140 nm, about 60 nm to about 120 nm, about 80 nm to about 120 nm, or about 90 nm to about 110 nm. Without being bound by theory, the anti-reflective layer 356 can increase image sharpness by preventing light from exiting the waveguide substrate other than at out-coupler grating.

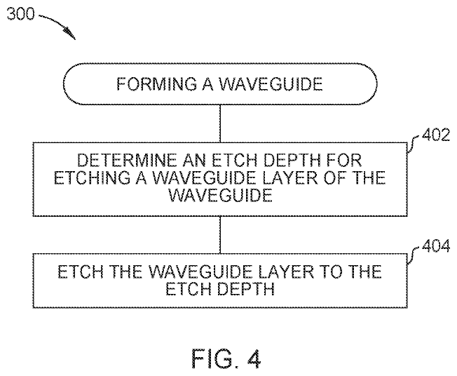

FIG. 4 is a flowchart of a method for forming a waveguide according to embodiments described herein. At step 402, an etch depth for etching a waveguide layer of the waveguide is determined, wherein the etch depth is less than a grating depth of one or more gratings of the waveguide. For example and with reference to FIG. 3, a depth 318, e.g., etching depth, for etching a waveguide layer 108 of a waveguide 100 may be determined, wherein the depth 318 is less than a depth 310 of one or more gratings (e.g., in-coupler grating 102, pupil expander grating 104, or out-coupler grating 106) of the waveguide 100. For example, the etch depth can include a depth of about 40% to about 60% of the grating depth.

Optionally, the etch depth based on the first depths and duty cycles of the one or more gratings. Optionally, the etch depth is determined based on one or more phase tears at one or more boundaries between the waveguide layer and the one or more gratings. Optionally, the etch depth is determined based on a modulation transfer function (MTF) of the waveguide.

At operation 404, the waveguide layer 108 is etched to the etch depth. Continuing the example from above, the waveguide layer 108 is etched to the depth 318. Optionally, the second sub-layer 354 may be etched, thereby improving the etch precision compared to the first sub-layer 352. Optionally, the second sub-layer 354 may be etched to remove the second sub-layer 354, exposing the first sub-layer 352 in the waveguide layer 108.

Overall, the present disclosure provides a waveguide combiner having a waveguide layer that is etched to an etched depth to increase the image sharpness compared to conventional waveguide combiners. Etching the waveguide layer to the determined depth, as described in this disclosure, can be independently implemented in a wide class of waveguides without changing the designs or architectures of the grating and non-grating regions of those waveguides.

While the foregoing is directed to embodiments of the present disclosure, other and further embodiments of the disclosure may be devised without departing from the basic scope thereof, and the scope thereof is determined by the claims that follow.

What is claimed is:

1. A waveguide, comprising:
a plurality of gratings, the plurality of gratings comprising grating structures disposed over a waveguide substrate, the grating structures comprising a grating depth; and
a waveguide layer disposed over the waveguide substrate between each of the plurality of gratings and an edge of the waveguide substrate, the waveguide layer having an etch depth, the etch depth is less than the grating depth.

2. The waveguide of claim 1, wherein the plurality of gratings comprise at least one of:
an in-coupler grating,
a pupil expander grating, or
an out-coupler grating.

3. The waveguide of claim 2, further comprising a first blanket area surrounding the in-coupler grating, the first blanket area comprising a first blanket depth.

4. The waveguide of claim 2, further comprising a second blanket area surrounding the pupil expander grating, the second blanket area comprising a second blanket depth.

5. The waveguide of claim 2, further comprising a third blanket area surrounding the in-coupler grating, the third blanket area comprising a third blanket depth.

6. The waveguide of claim 1, wherein the grating structures comprise a duty cycle.

7. The waveguide of claim 1, further comprising an anti-reflective layer disposed over the plurality of gratings and the waveguide layer.

8. The waveguide of claim 1, wherein the waveguide layer comprises:
a first sub-layer disposed over the waveguide substrate; and
a second sub-layer disposed over the first sub-layer.

9. The waveguide of claim 8, wherein the first sub-layer comprises niobium oxide, and the second sub-layer comprises titanium oxide.

10. The waveguide of claim 8, wherein the first sub-layer comprises about 50% to about 100% of a waveguide layer depth, and the second sub-layer comprises about 1% to about 50% of the waveguide layer depth.

11. A waveguide, comprising:
a plurality of gratings, the plurality of gratings comprising grating structures disposed over a waveguide substrate, the grating structures comprising a grating depth; and
a waveguide layer disposed over the waveguide substrate between each of the plurality of gratings and an edge of the waveguide substrate, the waveguide layer comprising:
a first sub-layer disposed over the waveguide substrate; and
a second sub-layer disposed over the first sub-layer,
wherein the waveguide layer comprises an etch depth from a top surface of the second sub-layer to the top surface of the grating structures.

12. The waveguide of claim 11, further comprising:
a first blanket area surrounding an in-coupler grating, the first blanket area comprising a first blanket depth;
a second blanket area surrounding an pupil expander grating, the second blanket area comprising a second blanket depth; and
a third blanket area surrounding an out-coupler grating, the third blanket area comprising a third blanket depth.

13. The waveguide of claim 11, further comprising an anti-reflective layer disposed over the plurality of gratings and the waveguide layer.

14. The waveguide of claim 11, wherein the first sub-layer comprises niobium oxide, and the second sub-layer comprises titanium oxide.

15. The waveguide of claim 11, wherein the first sub-layer comprises about 50% to about 100% of a waveguide layer depth, and the second sub-layer comprises about 1% to about 50% of the waveguide layer depth.

16. A method for forming a waveguide, comprising:
determining an etch depth for etching a waveguide layer of a waveguide, the waveguide layer comprising a first sub-layer and a second sub-layer, wherein the etch depth is less than a grating depth of a plurality of gratings of the waveguide; and
etching the second sub-layer to the etch depth.

17. The method of claim 16, wherein the plurality of gratings comprise at least one of:
an in-coupler grating,
a pupil expander grating, or
an out-coupler grating.

18. The method of claim 16, wherein determining the etch depth comprises determining the etch depth based on the grating depth and a duty cycle of the plurality of gratings.

19. The method of claim 16, wherein determining the etch depth comprises determining the etch depth based on one or more phase tears at one or more boundaries between the waveguide layer and the plurality of gratings.

20. The method of claim 16, wherein determining the etch depth comprises determining the etch depth based further on a modulation transfer function (MTF) of the waveguide.
